(19) United States
(12) Patent Application Publication
(10) Pub. No.: US 2023/0047352 A1
(43) Pub. Date: Feb. 16, 2023

(54) APPARATUS FOR DISPENSING VISCOUS FLUID AND METHOD FOR DISPENSING VISCOUS FLUID WITH THE SAME

(71) Applicant: Tonsan Adhesives, Inc., Beijing (CN)

(72) Inventors: Jing LI, Langfang (CN); Zhenzhong LI, Langfang (CN); Yutao HU, Beijing (CN)

(21) Appl. No.: 17/757,144

(22) PCT Filed: Dec. 8, 2020
(86) PCT No.: PCT/CN2020/134487

§ 371 Date: Jun. 9, 2022

(30) Foreign Application Priority Data
Dec. 9, 2019 (CN) 201911249856.1

(51) Int. Cl. B05C 17/01; B05C 17/005

(52) U.S. Cl. CPC B05C 17/0103; B05C 17/00556

(57) ABSTRACT

Provided are an apparatus (1) for dispensing viscous fluid and a method for dispensing viscous fluid with the same. The apparatus (1) comprises: a support structure (2) adapted to receive a plurality of cartridges (41, 42); and a plurality of push rods (31, 32) and a transmission means (7) that are mounted to the support structure (2), each push rod being configured to be translatable in a longitudinal direction thereof. The transmission means (7) is configured to receive a driving force from a power source and transmit the driving force to the plurality of push rods (31, 32) at different transmission ratios so as to translate the plurality of push rods at different speeds.

### TECHNICAL FIELD

The invention relates to the field of fluid dispensing, and more particularly to an apparatus for dispensing viscous fluid and a method for dispensing viscous fluid with the apparatus.

### BACKGROUND ART

Adhesive is usually packaged in the form of e.g. a barrel or a tube, and the tube includes toothpaste tube, plastic tube and soft package. For a soft package that is in the shape of e.g. a sausage, its volume will be greatly reduced upon compression after the adhesive is used up, thereby reducing the expenses on transportation and hazardous waste treatment, and saving costs. For these reasons, it becomes more and more popular among the users.

Most soft packages currently available in the market contain a single component, and only few of them contain multiple components. There are two main reasons for this: first, a packing machine can only produce soft packages of one diameter; second, current apparatuses for dispensing viscous fluid can only dispense a plurality of soft packages of different components having identical lengths. However, when different components in a finally dispensed mixture of viscous fluids are required to account for different proportions, if the soft packages have the same length, their diameters are necessarily different. Therefore, multiple packing machines are needed to produce these soft packages with different diameters, which unavoidably increases the cost on equipment.

### SUMMARY OF THE INVENTION

An object of the invention is to solve the above problems and/or other defects existing in the prior art.

To this end, the invention provides an apparatus for dispensing viscous fluid, the apparatus comprising: a support structure adapted to receive a plurality of cartridges; and a plurality of push rods and a transmission means that are mounted to the support structure, each push rod being configured to be translatable in a longitudinal direction thereof, the transmission means being configured to receive a driving force from a power source and transmit the driving force to the plurality of push rods at different transmission ratios so as to translate the plurality of push rods at different speeds.

According to an exemplary configuration, each push rod includes a toothed section, and the transmission means includes a plurality of rotatable cylindrical gears each of which meshes with the toothed section of a corresponding push rod, the product of rotational speed and outer diameter of each gear of the plurality of cylindrical gears being configured to be different than the product of rotational speed and outer diameter of another gear of the plurality of cylindrical gears.

According to another aspect of the invention, an apparatus for dispensing viscous fluid is provided, the apparatus comprising: a support structure adapted to receive a plurality of cartridges; a plurality of push rods mounted to the support structure, each push rod including a toothed section and being configured to be translatable in a longitudinal direction thereof; and a plurality of rotatable cylindrical gears which are mounted to the support structure and each of which meshes with the toothed section of a corresponding push rod so that a driving force can be transmitted from each cylindrical gear to the corresponding push rod, the product of rotational speed and outer diameter of each gear of the plurality of cylindrical gears being configured to be different than the product of rotational speed and outer diameter of another gear of the plurality of cylindrical gears.

According to an exemplary configuration, the plurality of cylindrical gears are configured to be rotatable at the same rotational speed and have different outer diameters.

In the above exemplary configuration, the apparatus or the transmission means may further include a plurality of wheels with the same outer diameter, each wheel being disposed coaxially with a corresponding cylindrical gear and configured to rotate in the same rotational speed as the corresponding cylindrical gear, at least one of the plurality of wheels being configured to receive a driving force from the power source and drive any other wheel of the plurality of wheels at the same rotational speed.

In the above exemplary configuration, the plurality of wheels may include at least one of: gears meshing with each other; gears meshing with the same gear; wheels drivingly connected with each other by a belt or chain; worm gears meshing with the same worm; and combinations thereof.

According to another exemplary configuration, each gear of the plurality of cylindrical gears is configured to be rotatable at a rotational speed that is different than a rotational speed of another gear of the plurality of cylindrical gears, and the plurality of cylindrical gears have the same outer diameter.

According to yet another exemplary configuration, each gear of the plurality of cylindrical gears is configured to be rotatable at a rotational speed that is different than a rotational speed of another gear of the plurality of cylindrical gears, and each gear of the plurality of cylindrical gears has an outer diameter that is different from an outer diameter of another gear of the plurality of cylindrical gears

In the above exemplary configurations, the apparatus or the transmission means may further include a plurality of wheels, each wheel of the plurality of wheels having a different outer diameter than an outer diameter of another wheel of the plurality of wheels, each wheel being disposed coaxially with a corresponding cylindrical gear such that the wheel is configured to rotate at the same rotational speed as the corresponding cylindrical gear, at least one of the plurality of wheels being configured to receive a driving force from the power source and drive any other wheel of the plurality of wheels to rotate at a different rotational speed.

In the above exemplary configuration, the plurality of wheels may include at least one of: gears meshing with each other; gears meshing with the same gear; wheels drivingly connected with each other by a belt or chain; and combinations thereof.

According to an exemplary configuration, each push rod includes a screw section, the transmission means includes a plurality of rotatable wheels each having a central threaded through-hole, the screw section of each push rod being matingly engaged within the central threaded through-hole of a corresponding wheel, and the product of a lead of screw section of each push rod and a rotational speed of its corresponding wheel being configured to be different than the product of a lead of screw section of another push rod and a rotational speed of its corresponding wheel.

According to yet another aspect of the invention, an apparatus for dispensing viscous fluid is provided, the apparatus comprising: a support structure adapted to receive a plurality of cartridges; a plurality of push rods mounted to the support structure, each push rod including a screw section and being configured to be translatable in a longitudinal direction thereof; and a plurality of rotatable wheels each having a central threaded through-hole, the screw section of each push rod being matingly engaged within the central threaded through-hole of a corresponding wheel so that a driving force can be transmitted from each wheel to the corresponding push rod, and the product of a lead of screw section of each push rod and a rotational speed of its corresponding wheel being configured to be different than the product of a lead of screw section of another push rod and a rotational speed of its corresponding wheel.

According to an exemplary configuration, each of the screw sections of the plurality of push rods has a lead that is different than a lead of another of the screw sections of the plurality of push rods, the plurality of wheels have the same outer diameter, at least one of the plurality of wheels being configured to receive a driving force from the power source and drive any other wheel of the plurality of wheels to rotate at the same rotational speed, and the plurality of wheels include at least one of: gears meshing with each other; gears meshing with the same gear; wheels drivingly connected with each other by a belt or chain; worm gears meshing with the same worm; and combinations thereof.

According to another exemplary configuration, the screw sections of the plurality of push rods have the same lead, the plurality of wheels have different outer diameters, at least one of the plurality of wheels being configured to receive a driving force from the power source and drive any other wheel of the plurality of wheels to rotate at a different rotational speed, and the plurality of wheels include at least one of: gears meshing with each other; gears meshing with the same gear; wheels drivingly connected with each other by a belt or chain; and combinations thereof.

According to an exemplary configuration, the apparatus further comprises a plurality of cartridges each of which is configured to be movable from a first position where the cartridge is received within the support structure to a second position configured to be suitable for receiving a soft tubular package into the cartridge.

In the above exemplary configuration, the plurality of cartridges have identical diameters to receive a plurality of soft tubular packages, each package of the plurality of soft tubular packages having the same diameter and a different length than another package of the plurality of soft tubular packages, the push rods being configured such that a first viscous fluid is dispensed from one of the cartridges at a first volumetric flow rate and a second viscous fluid is dispensed from another of the cartridges at a second volumetric flow rate that is different than the first volumetric flow rate.

According to an exemplary configuration, the apparatus further comprises a manifold mounted to a front end of the support structure and in fluid communication with an interior volume of each of the cartridges.

According to an exemplary configuration, the apparatus further comprises a motor associated with the support structure and configured to provide a driving force to the transmission means.

The invention further provides a method for dispensing viscous fluid with the apparatus described above, the method comprising the steps of: positioning a plurality of soft tubular packages within the plurality of cartridges respectively, each package of the plurality of soft tubular packages having the same diameter and a different length than another package of the plurality of soft tubular packages; and operating the apparatus such that viscous fluids are dispensed from the plurality of soft tubular packages by the plurality of push rods at different volumetric flow rates.

According to the concept of the invention, the apparatus for dispensing viscous fluid is provided with a specially designed transmission means, which can transmit the driving force from a power source at different transmission ratios to a plurality of push rods corresponding to a plurality of soft packages containing viscous fluids of different components respectively, so as to control the push rods to translate at different speeds. Therefore, the viscous fluids in a plurality of soft packages having different lengths can be always simultaneously dispensed at different volumetric flow rates from respective soft packages by the push rods. In this way, different proportions of viscous fluids having different components can be dispensed when a plurality of soft packages having the same diameter are used, and thereby just a single packing machine would be sufficient to meet the requirement of dispensing viscous fluids of different components in different proportions.

In the context of the invention, “viscous fluid” includes adhesive, sealant or the like; “a plurality of” means a number greater than or equal to two; “rotational speed” refers to angular velocity; and “front” and “rear” mean being located or directed forward and backward respectively with respect to a direction in which the viscous fluid is dispensed from the apparatus.

### BRIEF DESCRIPTION OF THE DRAWINGS

Various features, advantages and technical effects of the invention will become more apparent from the following description of exemplary embodiments of the invention with reference to the drawings. In the drawings:

FIG. 1 is an overall view of an apparatus for dispensing viscous fluid according to an embodiment of the invention;

FIG. 2 is a partially exploded view of the apparatus for dispensing viscous fluid shown in FIG. 1;

FIG. 3 illustrates a first exemplary configuration of at least part of the transmission means in an apparatus for dispensing viscous fluid according to the invention; and

FIG. 4 illustrates a second exemplary configuration of at least part of the transmission means in an apparatus for dispensing viscous fluid according to the invention.

The drawings are only schematic and not necessarily depicted to scale, and they only show elements necessary to illustrate the invention, while other elements may be omitted or merely mentioned simply. In other words, in addition to the components or elements shown in the drawings, the invention may also include other components or elements.

### DETAILED DESCRIPTION OF THE EMBODIMENTS

The invention will be further described in conjunction with specific embodiments. It should be noted that the embodiments are only some preferred examples of the invention, and the invention is not limited thereto.

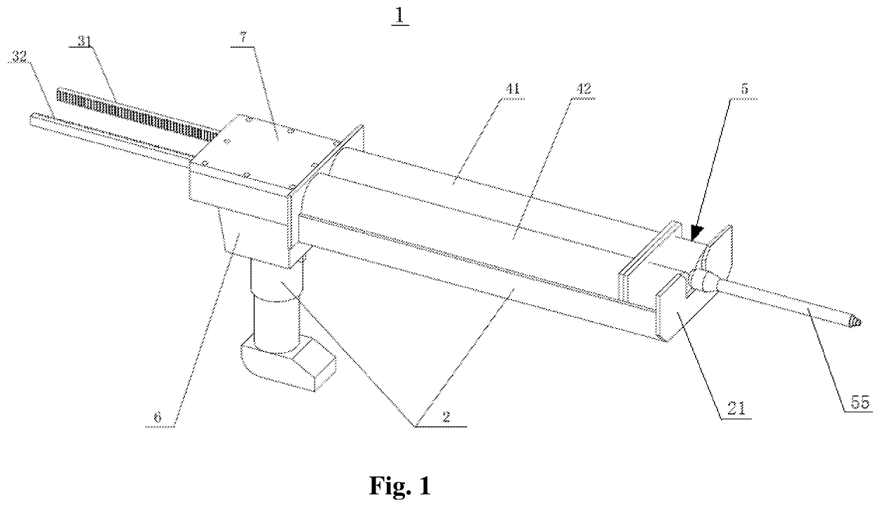

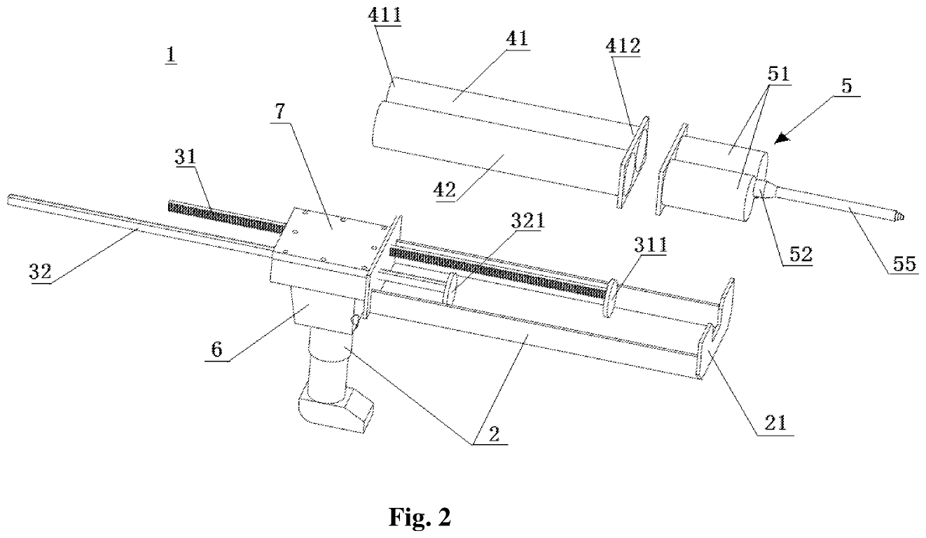

FIGS. 1 and 2 illustrate an exemplary apparatus 1 for dispensing viscous fluid according to the invention. The apparatus 1 for dispensing viscous fluid comprises a support structure 2, push rods 31, 32, and a transmission means 7. The support structure 2 constitutes a main framework of the apparatus 1 for dispensing viscous fluid, to which other devices and parts of the apparatus 1 may be mounted. For example, the push rods 31, 32 and the transmission means 7 are all mounted to the support structure 2. In addition, the support structure 2 is adapted to receive two tubular cartridges 41, 42 in each of which a viscous fluid to be dispensed is contained. In the illustrated embodiment, the support structure 2 is generally in the form of a hand-held glue gun, but the invention is not limited thereto, and the support structure 2 may be in the form of any portable or stationary apparatus.

In the illustrated embodiment, the tubular cartridges 41, 42 are arranged in parallel to the push rods 31, 32 within the support structure 2. The push rods 31, 32 are arranged within the cartridges 41, 42 respectively. Each push rod 31, 32 is configured to be translatable in an axial direction thereof (i.e. a longitudinal direction of the push rod, consistent with a lengthwise direction of the cartridge) so as to push a viscous fluid to be dispensed out of a corresponding cartridge 41, 42. For this purpose, each of the tubular cartridges 41, 42 is open at both ends in the lengthwise direction (i.e., taking the push rod 31 as an example, a front end 412 and a rear end 411 thereof as shown in FIG. 2). The push rods 31, 32 push the viscous fluids out from respective front ends of the cartridges 41, 42 by means of e.g. push plates 311, 321 fixed at respective front ends of the push rods. In the illustrated embodiment, the cartridges 41, 42 have the same diameter, but cartridges having different diameters may also be used as needed.

The apparatus 1 may comprise the cartridges 41, 42 as part of it. In this case, the cartridges 41, 42 may be configured to be movable from a first position where the cartridge is received within the support structure 2 to a second position configured to facilitate receiving into the cartridge a soft tubular package of viscous fluid to be dispensed, and then moved back to the first position where the cartridge is received within the support structure 2 for dispensing the viscous fluid. For example, the cartridges 41, 42 may be moved from the first position to the second position by pivoting around a shaft or a pivot for attaching the cartridge to the support structure 2 toward the outside of the support structure 2. The cartridges 41, 42 can be moved independently from each other, or connected integrally for a joint quick movement. Alternatively, it can be conceived that the cartridges 41, 42 are plastic tubes each containing a predetermined amount of viscous fluid. In this case, they are not part of the apparatus 1, but are just placed into the support structure 2 instead of being attached thereto.

The transmission means 7 is configured to receive a driving force from a power source and transmit the driving force to the push rods so as to translate the push rods. As the power source, a motor 6, connected with a battery or an external electric power supply electrically to receive electric power supplied to it, may be used. The motor 6 is drivingly connected to the transmission means 7 to provide a driving force thereto. In the case of using a battery, the motor 6 and the battery are adapted to be mounted together to the support structure 2 in particular in the form of a glue gun, for example mounted in the handle of the glue gun. The motor 6 may also be electrically connected directly to an external electric power supply without using a battery. It is easy for those skilled in the art to understand that other forms of power source, such as manual or pneumatic devices, may also be employed.

In order to dispense viscous fluid, the apparatus 1 further comprises a manifold 5 mounted to a front end 21 of the support structure 2. The manifold 5 is in fluid communication with an interior volume of each of the cartridges 41, 42 through a pair of inlet ports 51 to receive and gather the viscous fluids to be dispensed which are pushed out from the respective cartridges by the respective push rods. The manifold 5 may further be connected, for example, to a static mixing tube 55 through an outlet port 52 to blend the gathered viscous fluids and then dispense them to target locations.

According to the invention, the transmission means 7 is configured to transmit a driving force from the power source to the push rods 31, 32 at different transmission ratios, so that one of the push rods 31, 32 receives from the power source a driving force or power that is different than that received by the other of the push rods from the power source. Thus, the push rods 31, 32 are translated at different speeds, for example, the push rod 31 may be translated faster than the push rod 32. In this way, when soft packages of viscous fluids with the same diameter but different lengths are placed into the cartridges 41, 42 respectively (more specifically, for example, a relatively long soft package may be placed in the cartridge 41 corresponding to the push rod 31, while a relatively short soft package may be placed in the cartridge 42 corresponding to the push rod 32; that is, the larger the translational speed of a push rod is, a larger length the corresponding soft tubular package has) and then the apparatus 1 is operated, a relatively larger amount of viscous fluid in the long soft package is pushed out by the push rod 31 having a faster translation speed, and a relatively smaller amount of viscous fluid in the short soft package is pushed out by the push rod 32 having a slower translation speed. Therefore, it is possible that pushing of the viscous fluids in the two soft packages by the two push rods 31, 32 is started simultaneously (in this connection, it is easily understandable for those skilled in the art that since the two soft packages have different lengths, starting points of the strokes of the two push rods 31, 32 are set at different positions, i.e. the starting point of the stroke of the push rod 32 corresponding to the short soft package is closer to the front end of the apparatus 1 for dispensing viscous fluid than the starting point of the stroke of the push rod 31 corresponding to the long soft package) and also stopped simultaneously. That is, the viscous fluids in the two soft packages are simultaneously dispensed all the time. Since the amounts of viscous fluids in the two soft packages are different but their dispensing time is the same, the volumetric flow rates of viscous fluids in the two soft packages are different when dispensed. Thus, just a single apparatus for dispensing viscous fluid would suffice to realize dispensing of viscous fluids of different components in different proportions.

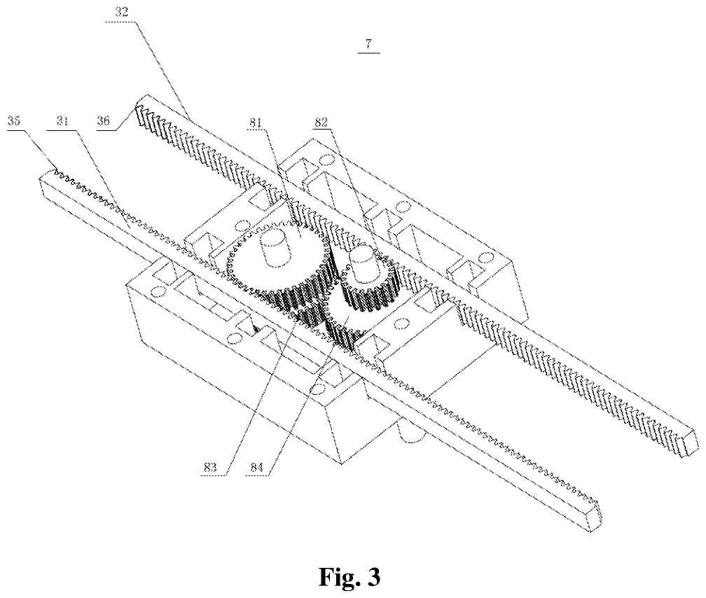

FIG. 3 illustrates an exemplary configuration of at least part of the transmission means 7 that transmits different driving forces to the push rods 31, 32 to translate them at different speeds. In this configuration, the push rods 31, 32 include toothed sections 35, 36 respectively (the toothed section can occupy part or all of the length of the push rod), and the transmission means 7 includes two cylindrical gears 81, 82 mounted e.g. in a gearbox as part of the support structure 2. For example, the cylindrical gear 81 meshes with the toothed section 35 of the push rod 31, and the cylindrical gear 82 meshes with the toothed section 36 of the push rod 32. The cylindrical gears 81, 82 are configured to transmit the driving force to the push rods 31, 32 respectively at different transmission ratios. To this end, in the embodiment shown in FIG. 3, the cylindrical gears 81, 82 are configured to have different outer diameters but be rotatable at the same rotational speed (i.e. angular velocity). This means that the tangential speed of the cylindrical gear 81 having a larger outer diameter is greater than the tangential speed of the cylindrical gear 82 having a smaller outer diameter (because a tangential speed of a cylindrical gear equals to the product of its rotational speed and radius), so that the translational speed of the push rod 31 meshed with the cylindrical gear 81 via the toothed section 35 is greater than the translational speed of the push rod 32 meshed with the cylindrical gear 82 via the toothed section 36.

To enable the cylindrical gears 81, 82 to rotate at the same rotational speed, the transmission means 7 shown in FIG. 3 further includes another two cylindrical gears 83, 84 having the same outer diameter and meshed with each other. The cylindrical gear 83 and the cylindrical gear 81 are both fitted on a first rotating shaft and both rotate along with the first rotating shaft, whereby the cylindrical gears 83, 81 can rotate at the same rotational speed. The cylindrical gear 84 and the cylindrical gear 82 are both fitted on a second rotating shaft and both rotate along with the second rotating shaft, whereby the cylindrical gears 84, 82 can also rotate at the same rotational speed. Since the cylindrical gears 83, 84 have the same outer diameter and mesh with each other, their rotational speeds are equal. Accordingly, the rotational speeds of the cylindrical gears 81, 82 are also equal to each other. Any of the cylindrical gears 83, 84 can receive a driving force from the power source either directly or indirectly via the corresponding first or second rotating shaft. It is easy for those skilled in the art to understand that according to the actual needs of transmitting driving force, the transmission means 7 may also include any other mechanism arranged between the power source (e.g. the motor 6) and the cylindrical gear 81 or 82 for changing the direction and/or magnitude of the transmitted driving force.

In the embodiment shown in FIG. 3, the cylindrical gears 83 and 84 having the same outer diameter mesh with each other and rotate at the same rotational speed. Alternatively, it can also be conceived that the cylindrical gears 83, 84 are both meshed with the same another gear, so they can also rotate at the same rotational speed (in this case, the cylindrical gears 83, 84 and the corresponding cylindrical gears 81, 82 will rotate in the same direction, which is suitable for the circumstance where the push rods 31 and 32 mesh with the cylindrical gears 81, 82 respectively at the same side of the cylindrical gears 81, 82 so as to translate in the same direction). Still alternatively, the cylindrical gears 83, 84 may be replaced by two worm gears with the same outer diameter engaged with the same worm, or two wheels with the same outer diameter drivingly connected with each other by a belt or a chain.

In the embodiment shown in FIG. 3, the cylindrical gears 81, 82 are configured to have different outer diameters but be rotatable at the same rotational speed. Alternatively, it can also be conceived that the cylindrical gears 81, 82 are configured to be rotatable at different rotational speeds and have identical outer diameters, or the two cylindrical gears 81, 82 have different rotational speeds and different outer diameters while the product of rotational speed and outer diameter of the cylindrical gear 81 is different from the product of rotational speed and outer diameter of the cylindrical gear 82. In this way, the cylindrical gears 81, 82 can also have different tangential speeds, which results in different translational speeds of the push rods 31, 32 meshed with the cylindrical gears 81, 82. In this case, the cylindrical gears 83, 84 in the above embodiment may be configured as gears with different outer diameters that are meshed with each other or meshed with the same another gear, or replaced by two wheels with different outer diameters drivingly connected with each other by a belt or a chain, while other structures are the same as those in the above embodiment, thereby the cylindrical gears 81, 82 with the same outer diameter have different rotational speeds.

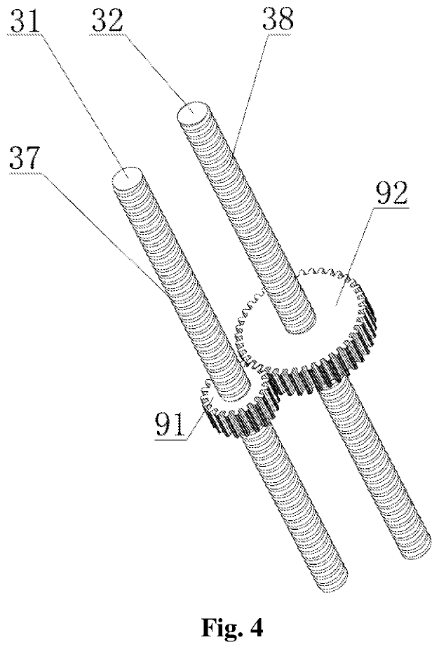

FIG. 4 illustrates another exemplary configuration of at least part of the transmission means 7. In this configuration, the push rods 31, 32 include screw sections 37, 38 respectively (the screw section can occupy part or all of the length of the push rod), and the transmission means 7 includes two rotatable wheels 91, 92 each with a central threaded through-hole that are mounted in e.g. a transmission box as part of the support structure 2, wherein the screw section of each push rod is matingly engaged within the central threaded through-hole of the corresponding wheel. In the embodiment shown in FIG. 4, the screw sections 37, 38 of the push rods 31, 32 are engaged in the respective central threaded through-holes of the wheels 91, 92. Thus, the push rods 31, 32 and the corresponding wheels constitute a screw-nut mechanism such that the rotational motion of the wheels 91, 92 can be converted into a translational motion of the corresponding push rods. Here, a non-threaded section of each push rod can be machined to have, for example, a D-shaped cross section and supported in a corresponding mating hole of the transmission box to prevent the push rod from rotating with the wheel. In addition, the position of the wheel should be fixed by means of appropriate means to prevent the wheel from moving in an axial direction of the push rod. Since a translational speed of a push rod is equal to a rotational speed of the corresponding wheel (e.g. revolutions per minute) multiplied by a lead of the screw section of the push rod, different translational speeds of the push rods 31, 32 can be realized by setting the rotational speeds of the wheels 91, 92 to be different and/or configuring the leads of the screw sections 37, 38 of the push rods 31, 32 to be different such that the product of the lead of screw section 37 of the push rod 31 and the rotational speed of its corresponding wheel 91 is different than the product of the lead of screw section 38 of the push rod 32 and the rotational speed of its corresponding wheel 92.

For example, the leads of the screw sections 37, 38 of the push rods 31, 32 may be made different from each other while the rotational speeds of the wheels 91, 92 are made the same. In this case, the wheels 91, 92 may be configured as two gears having the same outer diameter that are engaged with each other, or two gears having the same outer diameter both meshed with the same another gear, or two wheels having the same outer diameter that are drivingly connected with each other by a belt or a chain, or two worm gears having the same outer diameter engaged with the same worm.

Alternatively, the leads of the screw sections 37, 38 of the push rods 31, 32 may be made the same while the rotational speeds of the wheels 91, 92 are made different from each other. In this case, the wheels 91 and 92 may be configured as two gears with different outer diameters that are meshed with each other (as shown in the embodiment of FIG. 4), or two gears with different outer diameters that are meshed with the same another gear, or two wheels with different outer diameters drivingly connected with each other by a belt or a chain.

In the above two configurations, at least one of the wheels 91, 92 may be configured to receive a driving force from the power source via any mechanism for changing the direction and/or magnitude of the transmitted driving force depending on the actual needs of transmitting driving force.

In the above embodiments, the number of cartridges, push rods, as well as gears and wheels of the transmission means corresponding to respective push rods is two or two sets, so as to mix and dispense two different viscous fluids. However, the invention is not limited thereto, and it is also conceivable to employ three or more cartridges and push rods, so as to mix and dispense three or more different viscous fluids.

As described above, the apparatus for dispensing viscous fluid according to the invention is particularly suitable for dispensing, in different proportions, a variety of viscous fluids of different components from a plurality of soft packages having the same diameter but different lengths. However, the invention is not limited thereto, but may also be applied to a plurality of soft packages having different diameters and different lengths. In this case, if the diameter of a relatively short soft package is larger than the diameter of a relatively long soft package, it is even possible to dispense viscous fluids of different components in the same proportion. In other words, the apparatus for dispensing viscous fluid according to the invention enables viscous fluids of different components to be dispensed in either different or identical proportions by setting appropriate lengths and diameters of the cartridges and/or corresponding soft packages, thereby having a wide application.

The above description merely gives some exemplary embodiments relating to the spirit and principle of the invention. Those skilled in the art may understand that various changes can be made to the described embodiments without departing from the spirit and principle of the invention, and these changes and various equivalents thereof all fall within the scope defined by the claims of the invention.

16. An apparatus for dispensing viscous fluid, the apparatus comprising:
a support structure adapted to receive a plurality of cartridges; and
a plurality of push rods and a transmission means mounted to the support structure, each push rod being configured to be translatable in a longitudinal direction thereof, the transmission means being configured to receive a driving force from a power source and transmit the driving force to the plurality of push rods at different transmission ratios so as to translate the plurality of push rods at different speeds from each other.

17. The apparatus for dispensing viscous fluid according to claim 16, wherein each push rod includes a toothed section, and the transmission means includes a plurality of rotatable cylindrical gears, each gear of the plurality of rotatable cylindrical gears configured to mesh with the toothed section of a corresponding push rod, and wherein the product of rotational speed and outer diameter of each gear of the plurality of rotatable cylindrical gears being configured to be different than the product of rotational speed and outer diameter of another gear of the plurality of rotatable cylindrical gears.

18. The apparatus for dispensing viscous fluid according to claim 17, wherein each gear of the plurality of rotatable cylindrical gears has a different outer diameter and is configured to be rotatable at the same rotational speed as each of the other gears of the plurality of rotatable cylindrical gears.

19. The apparatus for dispensing viscous fluid according to claim 17, wherein the transmission means further includes a plurality of wheels, each wheel of the plurality of wheels having the same outer diameter, and each wheel being disposed coaxially with a corresponding cylindrical gear and configured to rotate at the same rotational speed as the corresponding cylindrical gear, at least one of the plurality of wheels being configured to receive a driving force from the power source and drive any other wheel of the plurality of wheels at the same rotational speed.

20. The apparatus for dispensing viscous fluid according to claim 19, wherein the plurality of wheels include at least one of: gears meshing with each other, gears meshing with the same gear, wheels drivingly connected with each other by a belt or chain, worm gears meshing with the same worm, and combinations thereof.

21. The apparatus for dispensing viscous fluid according to claim 17, wherein each gear of the plurality of rotatable cylindrical gears is configured to be rotatable at a rotational speed that is different than a rotational speed of another gear of the plurality of rotatable cylindrical gears, and the plurality of rotatable cylindrical gears have the same outer diameter.

22. The apparatus for dispensing viscous fluid according to claim 17, wherein each gear of the plurality of rotatable cylindrical gears is configured to be rotatable at a rotational speed that is different than a rotational speed of another gear of the plurality of rotatable cylindrical gears, and each gear of the plurality of rotatable cylindrical gears has an outer diameter that is different from an outer diameter of another gear of the plurality of rotatable cylindrical gears.

23. The apparatus for dispensing viscous fluid according to claim 16, wherein the transmission means further includes a plurality of wheels, each wheel of the plurality of wheels having a different outer diameter than an outer diameter of another wheel of the plurality of wheels, each wheel being disposed coaxially with a corresponding cylindrical gear such that the wheel is configured to rotate at the same rotational speed as the corresponding cylindrical gear, at least one of the plurality of wheels being configured to receive a driving force from the power source and drive any other wheel of the plurality of wheels to rotate at a different rotational speed.

24. The apparatus for dispensing viscous fluid according to claim 23, wherein the plurality of wheels includes at least one of: gears meshing with each other, gears meshing with the same gear, wheels drivingly connected with each other by a belt or chain, and combinations thereof

25. The apparatus for dispensing viscous fluid according to claim 16, wherein each push rod includes a screw section, and wherein the transmission means includes a plurality of rotatable wheels each having a central threaded through-hole, the screw section of each push rod being matingly engaged within the central threaded throughhole of a corresponding wheel, and the product of a lead of screw section of each push rod and a rotational speed of its corresponding wheel being configured to be different than the product of a lead of screw section of another push rod and a rotational speed of its corresponding wheel.

26. The apparatus for dispensing viscous fluid according to claim 25, wherein each of the screw sections of the plurality of push rods has a lead that is different than a lead of another of the screw sections of the plurality of push rods, the plurality of wheels have the same outer diameter,
at least one of the plurality of wheels is configured to receive a driving force from the power source and drive any other wheel of the plurality of wheels to rotate at the same rotational speed, and
the plurality of wheels include at least one of: gears meshing with each other, gears meshing with the same gear, wheels drivingly connected with each other by a belt or chain, worm gears meshing with the same worm, and combinations thereof.

27. The apparatus for dispensing viscous fluid according to claim 25, wherein the screw sections of the plurality of push rods each have the same lead, and the plurality of wheels each have different outer diameters,
at least one wheel of the plurality of wheels is configured to receive a driving force from the power source and drive any other wheel of the plurality of wheels to rotate at a different rotational speed, and
the plurality of wheels include at least one of: gears meshing with each other, gears meshing with the same gear, wheels drivingly connected with each other by a belt or chain, and combinations thereof.

28. The apparatus for dispensing viscous fluid according to claim 16, further comprising a plurality of cartridges each of which is configured to be movable from a first position where the cartridge is received within the support structure to a second position configured to be suitable for receiving a soft tubular package into the cartridge.

29. The apparatus for dispensing viscous fluid according to claim 28, wherein the plurality of cartridges have identical diameters to receive a plurality of soft tubular packages each package of the plurality of soft tubular packages having the same diameter and a different length than another package of the plurality of soft tubular packages, the push rods being configured such that a first viscous fluid is dispensed from one of the cartridges at a first volumetric flow rate and a second viscous fluid is dispensed from another of the cartridges at a second volumetric flow rate that is different than the first volumetric flow rate.

30. The apparatus for dispensing viscous fluid of claim 16, further comprising a manifold mounted to a front end of the support structure and in fluid communication with an interior volume of each of the cartridges.

31. The apparatus for dispensing viscous fluid of claim 16, further comprising a motor associated with the support structure and configured to provide a driving force to the transmission means.

32. A method for dispensing viscous fluid with the apparatus of claim 16, the method comprising the steps of:
positioning a plurality of soft tubular packages within the plurality of cartridges respectively, each package of the plurality of soft tubular packages having the same diameter and a different length than another package of the plurality of soft tubular packages; and
operating the apparatus such that viscous fluids are dispensed from the plurality of soft tubular packages by the plurality of push rods at different volumetric flow rates.
